(19) United States
(12) Patent Application Publication
(10) Pub. No.: US 2026/0330361 A1
(43) Pub. Date: Oct. 22, 2026

(54) FLEXIBLE PLAYBOOK TRIGGERING

(71) Applicant: ServiceNow, Inc., Santa Clara, CA (US)

(72) Inventors: Min Wu, Pleasanton, CA (US); Yaron Guez, San Diego, CA (US); Jan Ove Kristian Olsson, Castro Valley, CA (US); Michel Abou Samah, San Diego, CA (US); Aaron Liebling, Santa Fe, NM (US)

(21) Appl. No.: 19/182,788

(22) Filed: Apr. 18, 2025

(51) Int. Cl. G06Q 10/0631

(52) U.S. Cl. CPC G06Q 10/06316

(57) ABSTRACT

Embodiments of the subject technology relate to systems, methods, and computer-readable media for defining and executing a playbook. Input regarding a plurality of distinct triggers for a playbook can be received. The playbook can indicate a plurality of workflows. The plurality of distinct triggers can be set for the playbook. Execution of the playbook can be facilitated in response to satisfaction of a trigger of the plurality of distinct triggers.

### BACKGROUND

### 1. Technical Field

The present disclosure generally relates to playbook development, and more specifically to defining and implementing a playbook with multiple distinct triggers.

### 2. Introduction

In modern information technology (IT) environments, incidents such as system failures, and service disruptions are frequently encountered. Organizations often maintain large volumes of closed incident records, which contain valuable resolution knowledge. In turn, playbooks have been developed based on closed incident records to help in resolving future incidents. Specifically, human operators can implement playbooks that are developed from incident records to resolve future incidents.

### BRIEF DESCRIPTION OF THE DRAWINGS

The various advantages and features of the present technology will become apparent by reference to specific implementations illustrated in the appended drawings. A person of ordinary skill in the art will understand that these drawings only show some examples of the present technology and would not limit the scope of the present technology to these examples. Furthermore, the skilled artisan will appreciate the principles of the present technology as described and explained with additional specificity and detail through the use of the accompanying drawings in which:

FIG. 1A illustrates a diagram of an example cloud computing architecture, according to some examples of the present disclosure;

FIG. 1B is a block diagram illustrating an example network architecture that can be used to implement one or more embodiments, components, devices, nodes, systems, instances, and/or portions of the example cloud computing architecture, according to some examples of the present disclosure;

FIG. 2 illustrates a schematic diagram of an architecture 200 for defining a playbook with multiple triggers, according to some examples of the present disclosure;

FIG. 3 illustrates an example playbook architecture 300 of a playbook 302, according to some examples of the present disclosure;

FIG. 4 illustrates a flowchart 400 of an example method of generating and implementing a playbook with multiple distinct triggers, according to some examples of the present disclosure;

FIG. 5 illustrates a flowchart 500 of another example method of generating and implementing a playbook with multiple distinct triggers, according to some examples of the present disclosure;

FIG. 6 illustrates a flowchart 600 of an example method of maintaining a run policy for a playbook and implementing the run policy in executing the playbook, according to some examples of the present disclosure;

FIG. 7 illustrates an example processor-based system with which some embodiments of the subject technology can be implemented, according to some examples of the present disclosure.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a more thorough understanding of the subject technology. However, it will be clear and apparent that the subject technology is not limited to the specific details set forth herein and may be practiced without these details. In some instances, structures and components are shown in block diagram form to avoid obscuring the concepts of the subject technology.

In modern IT environments, incidents such as system failures, and service disruptions are frequently encountered. Organizations often maintain large volumes of closed incident records, which contain valuable resolution knowledge. In turn, playbooks have been developed based on closed incident records to help in resolving future incidents. Specifically, human operators can implement playbooks that are developed from incident records to resolve future incidents.

Playbooks can have a single trigger that causes execution of the playbook. For example, a playbook can be launched when an incident record is created. Accordingly, a copy of the playbook that corresponds to a trigger of incident record creation can be generated and stored for implementation when a new incident record is created. The same playbook can also be launched when an incident record is updated. However, since the playbook can only be associated with a single trigger, another copy of the playbook that corresponds to a trigger of incident record updating must be generated and stored. This process of duplicating the same playbook for each corresponding trigger and storing the copies of the playbook is a waste of computational resources.

The disclosed technology addresses the foregoing by defining multiple triggers for a single playbook. The triggers can be defined based on received input. In turn, each of the triggers can cause execution of the playbook without having to copy the playbook for each trigger. Accordingly, computational resources associated with duplicating the playbook for each trigger can be conserved.

When playbooks are only capable of being associated with a single trigger, the playbook becomes unnecessarily linked to a trigger record of the trigger. In turn, only information from the trigger record can be passed to the playbook as input. For example, if a playbook is launched by new lead creation in a leads record for a sales team, then only information in the leads record can be used to execute the playbook, as the leads record is the parent record for the playbook. Limiting a playbook to a single trigger record is problematic, as it limits what information can be passed to the playbook as input. Further, limiting a playbook to a single trigger record can necessitate copying the playbook for each trigger record if the playbook can be launched from triggers with different records, thereby wasting computational resources associated with duplicating the playbook.

The disclosed technology addresses the foregoing by defining multiple triggers across different records for a single playbook. As a result, information can be passed to the playbook from the different records. Specifically, information can be passed to the playbook from the different records according to the trigger that is satisfied. Increasing the input diversity for the playbook is advantageous as it allows for a single copy of the playbook to execute on input from different records without having to copy the playbook for each record. In turn, computational resources associated with copying the playbook can be conserved.

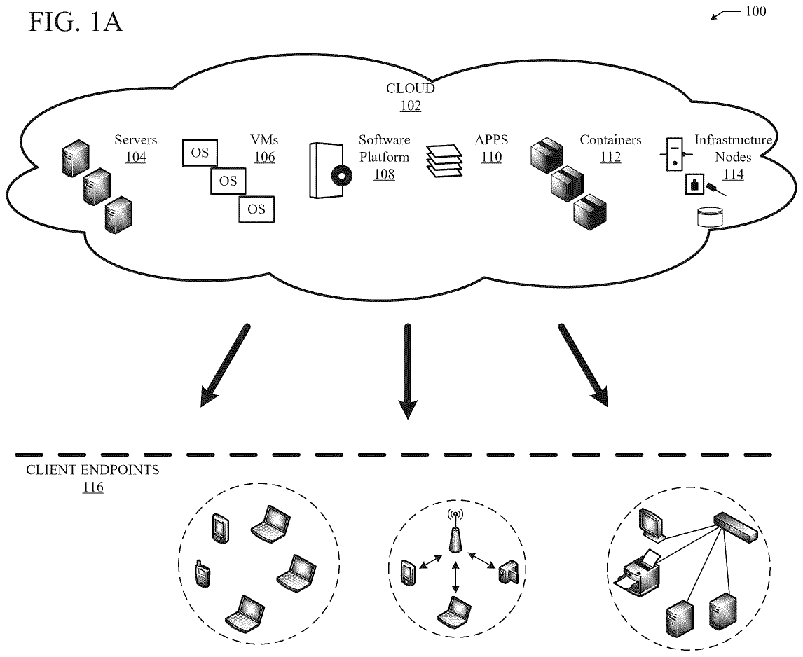

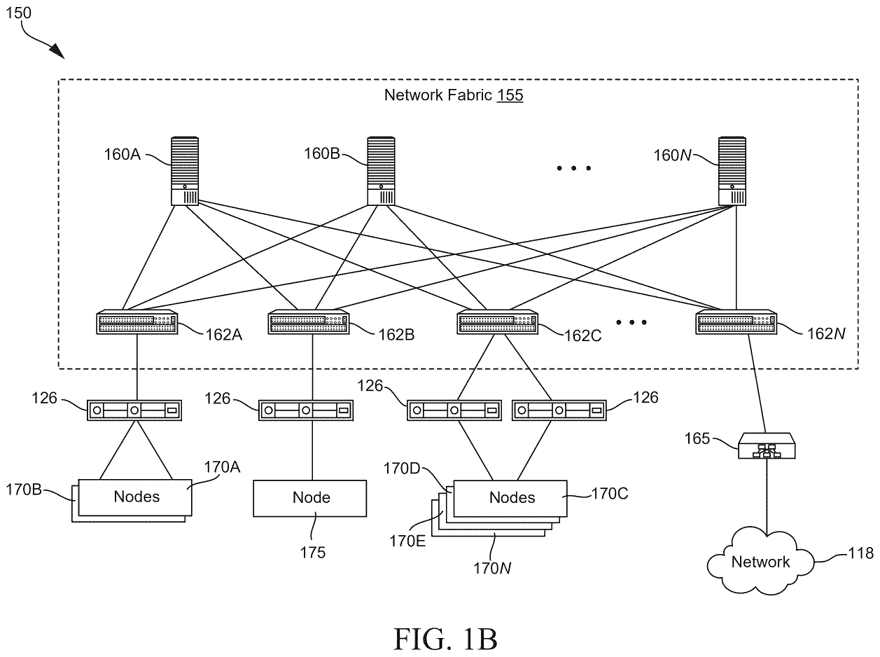

FIG. 1A illustrates a diagram of an example cloud computing architecture 100. The architecture can include a cloud 102. The cloud 102 can include one or more private clouds, public clouds, and/or hybrid clouds. Moreover, the cloud 102 can include cloud elements 104-114. The cloud elements 104-114 can include, for example, servers 104, virtual machines (VMs) 106, one or more software platforms 108, applications or services 110, software containers 112, and infrastructure nodes 114. The infrastructure nodes 114 can include various types of nodes, such as compute nodes, storage nodes, network nodes, management systems, etc.

The cloud 102 can provide various cloud computing services via the cloud elements 104-114, such as software as a service (SaaS) (e.g., collaboration services, email services, enterprise resource planning services, content services, communication services, etc.), infrastructure as a service (IaaS) (e.g., security services, networking services, systems management services, etc.), platform as a service (PaaS) (e.g., web services, streaming services, application development services, etc.), and other types of services such as desktop as a service (DaaS), information technology management as a service (ITaaS), managed software as a service (MSaaS), mobile backend as a service (MBaaS), etc.

The client endpoints 116 can connect with the cloud 102 to obtain one or more specific services from the cloud 102. The client endpoints 116 can communicate with elements 104-114 via one or more public networks (e.g., Internet), private networks, and/or hybrid networks (e.g., virtual private network). The client endpoints 116 can include any device with networking capabilities, such as a laptop computer, a tablet computer, a server, a desktop computer, a smartphone, a network device (e.g., an access point, a router, a switch, etc.), a smart television, a smart car, a sensor, a GPS device, a game system, a smart wearable object (e.g., smartwatch, etc.), a consumer object (e.g., Internet refrigerator, smart lighting system, etc.), a city or transportation system (e.g., traffic control, toll collection system, etc.), an internet of things (IoT) device, a camera, a network printer, or any smart or connected object (e.g., smart home, smart building, smart retail, smart glasses, etc.), and so forth.

In some cases, one or more embodiments, components, devices, nodes, systems, instances, and/or portions of the example cloud 102 can be implemented by and/or in a cloud network or datacenter. For example, any portion (or all) of the network 118, any of the content servers 120 (or all), and/or any of the system servers 126 (or all) can be implemented by and/or in a cloud network or datacenter. An example network architecture that can be used to implement any such network or datacenter (or any portion thereof), is shown in FIG. 1B and further described below.

FIG. 1B is a block diagram illustrating an example network architecture 150 that can be used to implement one or more embodiments, components, devices, nodes, systems, instances, and/or portions of the example cloud computing architecture 100, according to some examples of the present disclosure. The example network architecture 150 in FIG. 1B can represent, implement, deploy, host, support, include and/or provide the infrastructure for (or a portion of the infrastructure for) a datacenter (e.g., a cloud datacenter, an on-premises datacenter, a hybrid datacenter including private and public datacenters or datacenter portions, etc.), a network infrastructure, and/or any network environment (or portion thereof) such as, for example and without limitation, a cloud network/environment, a campus network/environment, an enterprise network/environment, an on-premises network/environment, a private network/environment, a public network/environment, a hybrid network/environment (e.g., a network/environment including both private and public networks/environments or portions thereof), and/or the like.

In some examples, the example network architecture 150 can host, implement, deploy, provide (e.g., provide the infrastructure for or a portion of the infrastructure for), support, and/or run/execute one or more applications, virtual machines (VMs), software containers, software tools, software functions, software algorithms, software models (e.g., artificial intelligence and machine learning models, software models implementing one or more classical algorithms, etc.), software applications, software packages, domains, databases, networks, services, workloads, service chains, functions, controllers, virtual network functions (VNFs), servers, drivers, hardware and/or software resources, software and/or hardware devices, software and/or hardware nodes, networking elements, serverless environments, serverless functions, cloud services and/or applications (e.g., software-as-a-service, function-as-a-service, infrastructure-as-a-service, platform-as-a-service, cloud applications, and/or any other cloud services and/or applications), execution environments, storage systems, processing/compute systems, memory systems, software and/or network sites, software policies, virtual/logical networks, overlay networks, software-defined networks (SDNs), interfaces, and/or any other code, component, element, application, service, etc.

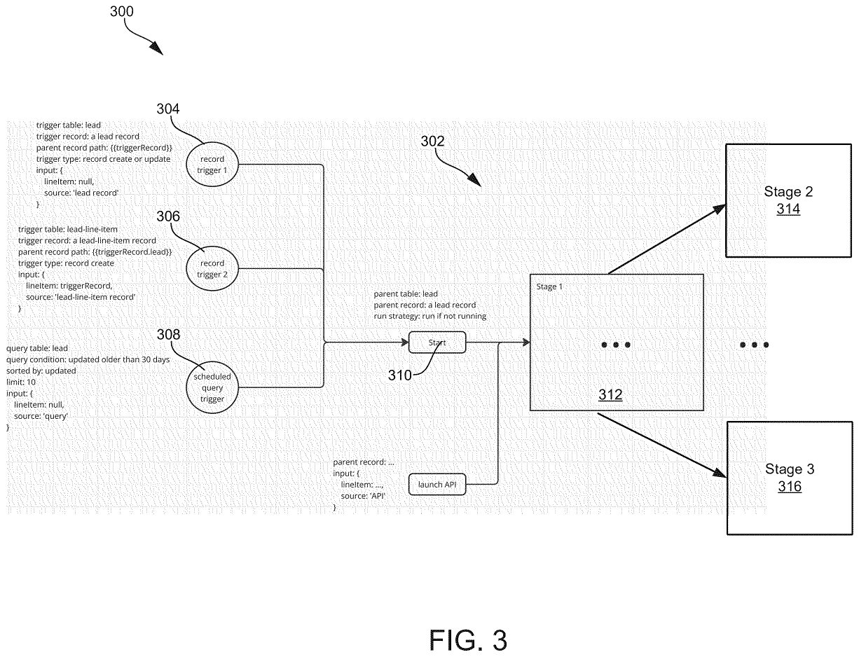

For example, the network architecture 150 can include, represent, implement, support, run, host, and/or provide the infrastructure for (or a portion of the infrastructure for) a datacenter, network (e.g., a cloud or cloud network, an on-premises network, a private network, a public network, a hybrid network, etc.), network infrastructure, and/or network environment used to host, implement, support, deploy, provide, and/or run quality control workloads/nodes, such as the worker nodes and the master node shown in FIG. 3 (and further described below). In such examples, the master node and each of the worker nodes can implement, include, represent, support, run, host, and/or provide one or more software applications/services, software systems, software packages, software modules, software units, software tools, interfaces, software/application code, functions, virtual environments, virtual applications, execution environments, virtualization elements (e.g., operating system-level virtualization elements, application-level virtualization elements, etc.), platforms, and/or any other components. In some cases, the master node and/or one or more of the worker nodes (or all) can each host and run one or more software containers, VMs, VNFs, applications (e.g., container applications, VM applications, and/or any other software applications), operating systems (OSs), functions, tools, and/or any other execution environment, code, tool, component, element, and/or package.

As shown in FIG. 1B, the network architecture 150 can include a network fabric 155. The network fabric 155 can include and/or represent the physical layer (e.g., underlay) and/or infrastructure of the network architecture 150. In some cases, the network fabric 155 can represent a data center(s) of one or more networks such as, for example, one or more cloud networks. The network fabric 155 can include network devices 160A-N (collectively referred to as “network devices 160” hereinafter) and network devices 162A-N (collectively referred to as “network devices 162” hereinafter), which are interconnected to route, relay, forward, and/or switch traffic in the network fabric 155. In some examples, the network devices 160 and the network devices 162 can include, implement, represent, and/or operate as switches (e.g., Layer 2 and/or Layer 3switches, aggregation switches, ingress and/or egress switches, top-of-rack (ToR) switches, core switches, spine switches, leaf switches, etc.), routers, hubs, bridges, gateways, provider edge devices, firewalls, network controllers, and/or any other type of networking devices. In FIG. 1B, the network fabric 155 includes or implements a spine-leaf topology. In such examples, the network devices 160 can represent spine nodes (e.g., spine switches or routers) and the network devices 162 can represent leaf nodes (e.g., leaf switches or routers). In other examples, the network fabric 155 can alternatively or additionally include or implement any other network topology.

The network devices 160 are interconnected with the network devices 162, and the network devices 162 can connect the network 118, the system servers 126 (e.g., including QC system(s) 130 and configuration system(s) 132), the network device 165, the nodes 170, and/or the node 175 with any portion of the network fabric 155 (e.g., including each other), the media device(s) 106, the content servers 120, an external network(s), a network overlay(s), a logical network(s), a network portion(s) or branch/branches, an external device(s), a service chain(s), a data center(s), a cloud network(s), and/or any other network(s) and/or compute/network element(s). In some cases, the network fabric 155 can include, host, and/or implement a network overlay(s) or logical network(s) that includes or implements one or more application services, servers, VMs, software containers, virtual resources (e.g., storage, memory, processors, network interfaces, virtual tools, execution environments, etc.), workloads, functions, virtual networks, hardware and/or software resources, and/or any other element(s).

Network connectivity in the network fabric 155 can flow from the network devices 160 to the network devices 162, and vice versa. The network devices 162 can route, switch, relay, forward, and/or bridge network traffic to and from other portions of the network fabric 155, other networks, e.g. network 118, various network elements, the network device 165, the nodes 170, the node 175, external client devices (e.g., clients devices external to the network fabric 155), data centers, clouds, tunnels, software-defined networks (SDNs) and/or SDN branches, on-premises networks, cloud tenants, cloud customers, applications, and/or any other network element. Thus, the network devices 162 can connect networks and network elements of the network fabric 155 with each other and with other networks and network elements.

In FIG. 1B, the system servers 126 can include or represent computer servers. Each of the system servers 126 can host, include, implement, and/or run one or more applications, functions, services, VMs, software containers, service chains, workloads, AI/ML models, algorithms, resources, cloud appliances, and/or any other software. In some cases, the system servers 126 connected to the network devices 162 can encapsulate and decapsulate packets to and from the network devices 162. For example, the system servers 126 can include, host, implement and/or operate one or more virtual routers, switches, gateways, endpoints, and/or network devices for tunneling packets between an overlay or logical layer hosted by, or connected to, the system servers 126 and an underlay layer represented by or included in the network fabric 155.

As shown in FIG. 1B, the system servers 126 can host, include, run, operate, and/or implement the nodes 170 and the node 175. In some examples, the nodes 170 and the node 175 can represent cloud instances. For example, in some cases, the nodes 170 and the node 175 can each represent a virtual server and/or environment (e.g., a VM, a software container, etc.) that uses compute, memory, storage, and/or networking resources on the cloud (e.g., network architecture 150) for respective workloads. In some embodiments, the nodes 170 and/or the node 175 can perform parallel computing using, for example, multithreading. Each of the nodes 170 and/or the node 175 can include, host, implement, run, operate, and/or represent one or more server applications, software containers, VMs, software, services, AI/ML models, algorithms, cloud appliances, software functions, service chains, workloads, server-side functions, processing resources, computers, and/or any other software and/or hardware component.

For example, in some cases, each of the nodes 170 and/or the node 175 can represent a node instance that includes, implements, hosts, and/or runs a software container(s). The software container associated with a node can provide, run, deploy, include, operate, represent, and/or implement an execution environment(s), a workload(s), an application(s), software, an AI/ML model(s), an algorithm(s), a driver(s), a computer service(s), a software model(s) and/or algorithm(s), a function(s), a software library/libraries, a software tool(s), a software/cloud appliance(s), a software component(s), and/or any other computing element(s). In some cases, the nodes 170 and the node 175 can represent cloud node instances running respective computing environments, such as software containers or VMs. Each VM can include software, services, drivers, applications, libraries, functions, virtualized resources (e.g., processors, memory, storage, network interfaces, etc.), and/or workloads installed, implemented, included, and/or running/executed on a guest operating system (OS) associated with the VM.

The network architecture 150 can deploy, run, implement, host, and/or support various resources (e.g., hosts, applications, services, functions, VMs, software containers, workloads, cloud appliances, service chains, hardware and/or software resources, AI/ML models, algorithms, application platforms, operating systems, etc.) using the system servers 126, the network fabric 155, the network devices 160, the network devices 162, the network device 165, the nodes 170, the node 175, and the network 118.

In some cases, the network architecture 150 can implement and/or can be part of one or more cloud networks and can provide one or more cloud computing services such as, for example and without limitation, cloud storage, serverless computing, software-as-a-service (SaaS) (e.g., streaming services, content delivery services, video services, Internet content services, application services, conferencing services, etc.), infrastructure-as-a-service (IaaS), platform-as-a-service (PaaS) (e.g., web services, streaming services, content delivery services, content library services, conferencing services, video services, Internet content services, sharing and/or collaboration services, etc.), function-as-a-service (FaaS), and/or any other types of services such as desktop-as-a-service (DaaS), information technology management-as-a-service (ITaaS), managed software-as-a-service (MSaaS), mobile backend-as-a-service (MBaaS), etc.

The network architecture 150 described above illustrates a non-limiting example network architecture provided herein for explanation purposes. It should be noted that other network architectures can be implemented in other examples and are also contemplated herein. One of ordinary skill in the relevant art(s) will recognize in view of the disclosure that other network architectures can be used to implement one or more of the concepts, systems, techniques, devices, software, applications, methods, embodiments, elements, examples, and/or components disclosed herein.

Various embodiments of the subject technology can be implemented through the cloud computing architecture 100 shown in FIG. 1A and the network architecture 150 shown in FIG. 1B.

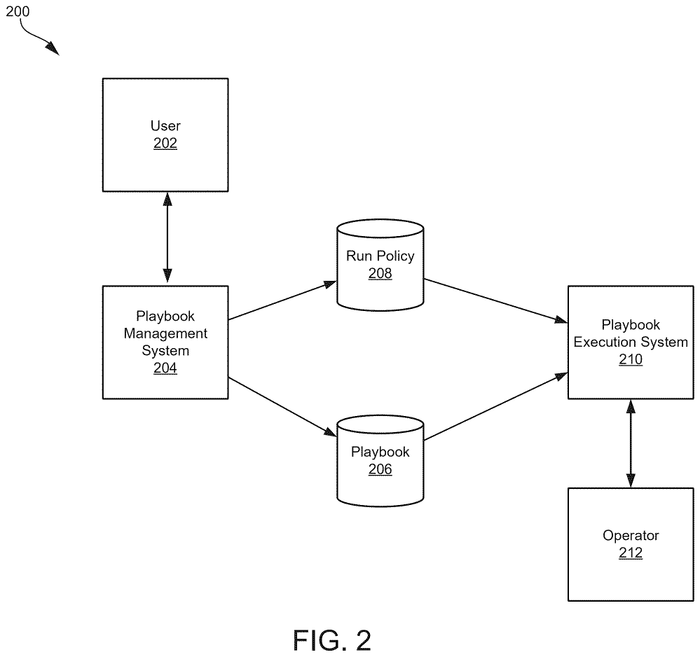

FIG. 2 illustrates a schematic diagram of an architecture 200 for defining a playbook with multiple triggers, according to some examples of the present disclosure. The architecture 200 comprises a user 202, a playbook management system 204, and a playbook datastore 206.

The user 202 can comprise a graphical user interface through which the user 202 can communicate with the playbook management system 204 regarding maintenance of a playbook, e.g. creation and updating of the playbook. A playbook can be maintained by the playbook management system 204 based on input provided by the user 202. Further, a playbook can be created based on an applicable occurrence and objective defined in relations to the occurrence, such as an incident with a resolution.

Incidents can have varying occurrence rates. An incident can be a unique incident with a low chance of occurring again. For example, an incident can be a unique attack launched against an enterprise. Alternatively, an incident can be a frequently occurring incident. For example, an incident can be a routine problem associated with accessing an email account. An incident can either have a resolution or not have a resolution. A resolution to an incident, as used herein, can include fixing a disruption, e.g. to a service or infrastructure, as part of the incident. A resolution to an incident, as used herein, can also include achieving a state in response to a disruption that is acceptable to a controlling authority. For example, a resolution to an incident can be that the disruption has been eliminated and any effects caused by the disruption have been remedied.

While the technology is described in this disclosure with respect to incidents, in various embodiments, the technology can be practiced with respect to other applicable occurrences, such as changes and alerts. For example, the technology can be applied to repetitive workflow occurrences. Further, technology described herein can be practiced in other applicable domains outside of incident resolution, such as sales operations, marketing operations, financial operations, and legal operations.

A playbook, as used herein, can comprise a plurality of stages that can be followed in achieving an objective for a specific occurrence, e.g. a resolution for an incident or performing an operation based on updating of specific data in a record. The stages can be related and traversed in a specific order in achieving the objective. For example, a playbook can comprise a stage for identifying a cause of an incident, a stage for containing the cause of the incident, and a stage for remedying changes caused by the incident. In another example, a playbook can comprise a stage of interacting with a customer to identify an IT issue and a stage of remedying the IT issue. In various embodiments, a playbook can correspond to an incident or a type of incident. For example a playbook can comprise steps for resolving a specific IT issue. In another example, a playbook can comprise steps for resolving a broad category of IT issues that are all the same type of IT incident.

Stages in a playbook can be formed through workflows, otherwise subflows, that form the playbook. In various embodiments, only a subset of the stages/workflows can be traversed in executing the playbook to attempt to achieve the objective of the playbook. Specifically, the stages/workflows can be organized in a hierarchical structure, e.g. tree structure. More specifically, the stages can form one or more branches in the hierarchical structure that can be traversed along a specific traversal path in attempting to achieve the object of the playbook. The traversal path can exclude specific stages/workflows such that the specific stages/workflows are not run when executing the playbook according to the traversal path.

A hierarchical structure of a playbook can comprise different conditional actions, otherwise referred to as resolution steps, and corresponding conditions that guide completion of the actions. Specifically, stages/workflows in the hierarchical structure can comprise different conditional actions and corresponding conditions that cause performance of one or more of the conditional actions in starting, executing, or otherwise completing the stage/workflow of the playbook. The conditional actions can form different stages, e.g. branches, in the hierarchical structure and corresponding conditions can guide which stages/workflows, corresponding to the conditional actions, are performed in traversing the hierarchical structure. For example, a playbook can comprise a conditional action that if met causes performance of a specific stage/subflow within the playbook. Different stages/workflows of the hierarchical structure can be traversed based on whether corresponding conditions of the conditional actions that form the stages are met or not. Specifically, nodes in the hierarchical structure can comprise decision points to determine whether a condition has been met. In turn, a specific stage/workflow of the hierarchical tree that is connected to the node, or otherwise includes the node, can be traversed based on whether the condition has been met. For example, branch A, that corresponds to a first stage/workflow and is connected to a node, can be traversed if the condition is met. Further in the example, branch B, that corresponds to a second stage/workflow and is connected to the node, can be traversed if the condition is not met.

A playbook can comprise an automated action. An automated action can comprise an action that is capable of being performed/is performed by a system other than a human in executing a playbook. For example, an automated action can be performed by an agent operator in executing the playbook to achieve an objective. Further, a playbook can comprise a manual action. A manual action can comprise an action that is capable of being performed/is performed by a human operator in executing a playbook. Automated and manual actions can be trigger-specific actions that form part of a stage/workflow in a hierarchical structure of a playbook.

In the architecture 200 shown in FIG. 2, the playbook management system 204 can maintain playbook data stored in the playbook datastore 206. Playbook data can include applicable data regarding a defined playbook. Specifically, playbook data can comprise data used in facilitating execution of the playbook, e.g. in a manual manner, an automated manner, or a semi-automated manner.

The playbook management system 204 can maintain the playbook based on input that is received from the user 202 through a user interface, e.g. through a graphical user interface (GUI). Specifically, the playbook system 204 can use the input received from the user 202 to generate a playbook. For example, the input can specify steps, workflows, actions, conditional actions, conditions for performing such actions to include in forming a playbook, instructions for forming the playbook, instructions for running the playbook, or a combination thereof. As follows, the playbook management system 204 can generate the playbook based on steps, workflows, actions, conditional actions, conditions for performing such actions to include in forming a playbook, instructions for forming the playbook, instructions for running the playbook, or a combination thereof that are included in the input. Further, the playbook system 204 can use the input received from the user 202 to modify an existing workflow, e.g. as part of maintaining the workflow. For example, input from the user 202 can specify switching an order of workflows in a playbook. As follows, the playbook management system 204 can update playbook data for the playbook to switch the order of the workflows in the playbook.

Playbook data of a playbook can specify triggers for the playbook. The playbook management system 204 can update the playbook data for the playbook to associate the triggers with the playbook. The triggers can be defined based on input that is received from the user 202 through a GUI. Specifically, the playbook management system 204 can receive from the user 202 input defining triggers for the playbook. In turn, the playbook management system 204 can associate the triggers with the playbook.

The playbook can be associated with multiple distinct triggers. A trigger for the playbook as used herein, can comprise one or more conditions that if met can cause or potentially cause execution of the playbook. The conditions can be specified by input provided by the user 202 which can be used by the playbook management system 204 to define the corresponding trigger and associate the trigger with the playbook. While a trigger can cause execution of the playbook, as will be discussed in greater detail later, execution of the playbook can ultimately be controlled by a run policy associated with the playbook. Therefore, even though a trigger might be satisfied, rules of the run policy might specify not running the playbook and as a result the playbook will not be launched even through the trigger is satisfied.

A trigger defined for the playbook can comprise a record-based trigger. A record-based trigger, as used herein, can comprise one or more conditions related to a record associated with a playbook and defined for the trigger. A record associated with the playbook, as used herein, can comprise an applicable record that is used in running the playbook. Specifically, a record associated with the playbook can pass information to the playbook that can ultimately be used in executing the playbook. For example, a record associated with the playbook can comprise a parent record for the playbook that is used in executing the playbook. Further, a record associated with a playbook can comprise a record that is used in triggering a playbook. For example, a record associated with the playbook can comprise a trigger record for the playbook that is used in triggering the playbook.

Conditions included in a record-based trigger can define a trigger record for the trigger. For example, the conditions can specify that a sales leads table can serve as a trigger record for a trigger of the playbook. Further, conditions included in a record-based trigger can comprise applicable operations performed in a defined trigger record for the trigger. For example, the conditions can specify that when new entries are added to the sales leads table should trigger execution of the playbook.

In various embodiments, the parent record of the playbook and the trigger record of a trigger for the playbook are the same record. Specifically, a defined trigger table can trigger the playbook when a record is created or updated within the table. Further, the defined trigger table can become the parent record for the playbook when the playbook is launched from the trigger table. The trigger table can either replace a previous parent record for the playbook or be the previous parent record for the playbook. For example, triggers for the playbook can all be defined for the same trigger table, therefore the trigger table can serve as the default parent record for the playbook.

In various embodiments, the parent record of the playbook and the trigger record of a trigger for the playbook are different records. Specifically, the user 202 can define a trigger record for a trigger that is different from a parent record for the playbook. More specifically, input received from the user 202 can specify a relationship between the trigger record and the parent record. In turn, the trigger record and the parent record can be connected, e.g. through a parent record path, to allow the playbook to be launched from the trigger record and then run from the parent record. For example, if the lead line-item table serves as the trigger table and has a reference column to the lead table, the parent record path can use this reference value to obtain the corresponding lead record from a lead line-item trigger record. As follows, the launched playbook can use the lead record as the parent record and execute from the lead record.

A trigger record of a trigger can pass information to the playbook for running the playbook. When the trigger record is different from the parent record, then both the trigger record and the parent record can pass information for executing the playbook. Different triggers of the playbook can be associated with or defined by different trigger tables. As follows, information from the different trigger tables can be passed to and used in executing the playbook based on which corresponding triggers of the playbook are satisfied. For example, a first trigger can be associated with a first table and a second trigger can be associated with a second table. In turn, the information from either the first table or the second table can be passed for executing the playbook, depending on whether the first trigger or the second trigger is met.

A trigger defined for the playbook can also comprise a scheduled query trigger. A scheduled query trigger, as used herein, can comprise one or more temporal conditions that if satisfied, can cause execution of the playbook. Specifically, a scheduled query trigger can comprise a condition of querying, in relation to a temporal value, a specific record to see if a condition is met. As follows, satisfaction of the condition can trigger execution of the playbook. The user 202 can specify the timeframe/temporal value, the specific record to query, and the query condition for the record, e.g. parent record or trigger record. For example, the user 202 can configure a query that returns all contacts who have not logged in to the system within the past thirty days. This query can then be executed relative to a temporal value, e.g. daily, resulting in a launched execution of the playbook for each matching record.

The architecture 200 also comprises a run policy datastore 208, a playbook execution system 210, and an operator 212. The run policy datastore 208 functions to store data indicating run policies for executing the playbook. Run policies specify rules for controlling execution of the playbook. For example, run policies can specify the upper limit of the matched records, each of which can trigger a playbook execution. In another example, run policies can specify sorting criteria for choosing the top matching records from which to run playbook executions. Run policies for playbooks can be maintained by the playbook management system 204. Specifically, the playbook management system 204 can maintain run policies for specific playbooks based on input received from the user 202. For example, and to prevent excessive concurrent executions, the user 202 can set the upper bound of the number of the matched records that trigger a playbook execution. Further, the user 202 can set sorting criteria for sorting the top N matched records to trigger a playbook execution. By incorporating boundaries and sorting parameters, the user 202 can ensure that only the most relevant records launch playbook executions.

A run policy for the playbook can specify a run strategy against a parent record, which can govern when and how many playbooks/playbook instances can be launched. A run policy can specify running a playbook once. For example, a parent record can only be associated with a single playbook execution. As follows, the run policy can specify that if a trigger event occurs from a launched record's creation or update, and another playbook has been launched for the parent record, then subsequent trigger events fail to re-trigger execution of the playbook. Further, a run policy can specify to always run a playbook. For example, the run policy can specify that whenever a trigger event occurs, a playbook will be launched for the derived parent record. Additionally, a run policy can specify run the playbook if it is not concurrently running. For example, a run policy can specify a new playbook execution can be launched, if there is no currently running playbook associated with a parent record. Further, a run policy can specify running the playbook once within a specific timeframe. For example, a run policy can specify a playbook can be launched when a trigger event happens, if there has been no playbook launched for a parent record within a certain timeframe, such as a week or a month.

The playbook execution system 210 functions to execute or otherwise facilitate execution of the playbook. In executing or facilitating execution of the playbook, the playbook execution system 210 can interact with the operator 212. Specifically, the playbook execution system 210 can present stages, workflows, conditional actions and corresponding conditions of the playbook to the operator 212 as the operator 212 executes the playbook. Further, the playbook execution system can execute automated actions for the operator 212. The playbook execution system 210 can execute or otherwise facilitate execution of the playbook according to a traversal path. The traversal path can be formed based on satisfaction of different conditions of conditional actions forming stages and workflows in the playbook. As all conditions are not necessarily satisfied in the playbook, the traversal path can comprise a subset of the stages and workflows in the playbook.

The operator 212 can comprise an agent configured to execute the playbook in attempting to achieve an objective of the playbook. The agent can be a human agent or an automated agent that is configured to execute the actions of the playbook through the playbook execution system 210 to achieve the objective. Specifically, the agent can execute the actions of the playbook through the playbook execution system 210 in an automated, semi-automated, or manual manner. For example, the agent, when implemented as a human agent, can execute manual actions of the playbook that are presented to the agent by the playbook execution system 210. In another example, the agent, when implemented as an automated agent, can execute automated actions of the playbook. The operator 212 can comprise both an automated agent and a human agent that work in executing the playbook in a semi-automated manner. Specifically, the human agent can execute manual tasks of the playbook, while the automated agent can execute automated tasks of the playbook.

In executing/facilitating execution of the playbook, the playbook execution system 210 can determine whether a trigger of the playbook is satisfied. Specifically, the playbook execution system 210 can determine whether a trigger of multiple triggers for the playbook is satisfied. In turn, the playbook execution system 210 can pass information to the playbook according to the trigger that is satisfied and then execute the playbook accordingly. Additionally, the playbook execution system 210 can execute/facilitate execution of the playbook according to a run policy associated with the playbook. For example, the playbook execution system 210 can determine whether a trigger is satisfied and if a trigger is satisfied, whether the playbook should be launched according to one or more rules in a run policy for the playbook. As follows, if the playbook execution system 210 determines that the playbook should be launched according to the run policy, then the playbook execution system 210 can execute/facilitate execution of the playbook. Conversely, if the playbook execution system 210 determines that the playbook should not be launched according to the run policy, then the playbook execution system 210 can refrain from executing the playbook.

FIG. 3 illustrates an example playbook architecture 300 of a playbook 302, according to some examples of the present disclosure. The playbook can be created and implemented through the architecture 200 shown in FIG. 2. Specifically, the user 202 can provide input to the playbook management system 204 to generate the playbook 302 in the architecture 300 shown in FIG. 3. As follows, the playbook 302 can be implemented through the playbook execution system 210.

The playbook 302 comprises multiple triggers 304, 306, and 308. Specifically, the playbook 302 comprises a first record-based trigger 304, a second record-based trigger 306, and a scheduled query trigger 308. Any of the triggers 304, 306, and 308 can trigger the playbook 302 based on whether the conditions of the trigger are met.

The first record-based trigger 304 specifies that the trigger record for the trigger is the lead record. The first record-based trigger 304 specifies a parent record path from the trigger record to the parent record. With respect to the first record-based trigger 304, the trigger record is the lead record which is also the parent record for the playbook 302. Therefore, the path for the first record-based trigger 304 indicates that the parent record path is the trigger record. The first-record based trigger 304 specifies that the conditions for the trigger are the creation or updating of a record in the trigger record, e.g. the lead record. Accordingly, the first-record based trigger 304 can be launched whenever a record is created or updated in the lead record.

The second record-based trigger 306 specifies that the trigger record for the trigger is the lead-line-item record. This is a different record than the previously discussed parent record, the lead record, for the playbook 302. Accordingly, the parent record path for the second record-based trigger 306 specifies the path from the lead-line-item record to the lead record as “triggerRecord.lead”. The second record-based trigger 306 specifies that the condition for the trigger is the creation of a new record in the lead-line-item record, e.g. the trigger record. Accordingly, the second record-based trigger 306 can be launched whenever a record is created in the lead-line-item record.

The scheduled query trigger 308 specifies that the trigger record, otherwise query record or query table, for the trigger is the lead record. The scheduled query trigger 308 specifies that the condition for the trigger is records that were last updated 30 or more days ago. The scheduled query trigger 308 can be associated with a temporal value, e.g. a schedule, that specifies when the query should be run on the lead record. For example, the scheduled query trigger 308 can be configured to query the lead record daily. Further, the scheduled query trigger can be associated with a run policy for the playbook 302. Specifically, the run policy can specify that ten matching records a day can cause execution of the playbook 302. In other words, the run policy can limit to ten executions of the playbook 302 in response to the scheduled query trigger 308.

At module 310 in the architecture 300, the playbook 302 is started. Specifically, any of the triggers 304, 306, and 308 can cause execution of the playbook 302. More specifically, the playbook can be executed by passing the data from the triggers 304, 306, and 308 to the playbook 302. Moreover, the run strategy checking against the parent record, as previously described, can be performed. Further, the playbook can be executed by accessing the parent record, e.g. the lead record, and running off of the parent record. As discussed previously, the playbook 302 can be executed according to the run policy associated with the playbook 302, even if any of the triggers 304, 306, and 308 are satisfied.

As shown in the architecture 300, the playbook 302 can also be launched programmatically through API calls. Specifically, a user can select one or more records in the parent record and an indicia for launching the playbook 302. The API then receives a request with a unique playbook ID for the playbook 302, a parent record, which is used to launch the playbook 302 execution, and optional input object containing custom data to be used in the playbook 302 execution. If multiple parent records are selected, multiple API calls can be launched and each API call can launch a playbook 302 execution. In various embodiments, triggering execution of the playbook 302 through an API can force execution of the playbook 302 irrespective of any run policy constraints.

The playbook 302 is shown as comprising a first stage 312, a second stage 314, and a third stage 316. In various examples, a playbook comprises more than three stages. The inclusion of only three stages in the playbook 302 is done for simplicity purposes with the intent of showing the existence of two branches in the playbook 302. Specifically a first branch is formed by the second stage 314 and a second branch is formed by the third stage 316. In following the playbook 302 according to a traversal path, only one of the branches can be traversed. Specifically, both the second stage 314 and the third stage 316 can comprise conditional actions that are associated with conditions that guide which conditional action(s) and corresponding stage will be run during execution of the playbook 302. For example and after the first stage 312 is run, the second stage 314 can be run if a new sales lead is in a new organization and the third stage 316 can be run if the new sales lead is in a previously recognized organization. As follows, when executing the playbook only one of the second stage 314 and the third stage 316 can be run. When each of the second stage 314 and the third stage 316 correspond to different workflows, only a subset of the workflows in the playbook 302 can be run in executing the playbook. Workflows can be executed in combination satisfy an objective of the playbook 302. For example, the first stage 312 can correspond to a first workflow and the second stage 314 can correspond to a second workflow. As follows, the first stage 312 and the second stage 314 can be executed sequentially to satisfy the objective through the first and second workflows.

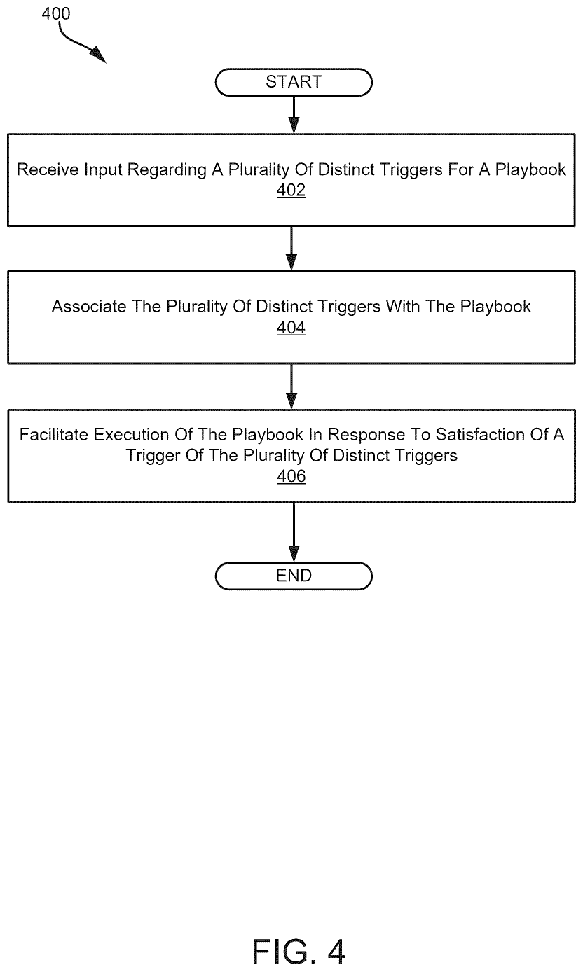

FIG. 4 illustrates a flowchart 400 of an example method of generating and implementing a playbook with multiple distinct triggers, according to some examples of the present disclosure. The method shown in FIG. 4 is provided by way of example, as there are a variety of ways to carry out the method. Additionally, while the example method is illustrated with a particular order of steps, those of ordinary skill in the art will appreciate that FIG. 4 and the modules shown therein can be executed in any order and can include fewer or more modules than illustrated. Each module shown in FIG. 4 represents one or more steps, processes, methods or routines in the method. The modules will be discussed with respect to the example architectures described herein.

At module 402, input regarding a plurality of distinct triggers for a playbook is received. The input can be received by a user associated with the playbook, e.g. an author of the playbook. Specifically, the input can be received through a user interface that is used in generating and maintaining playbooks. The playbook can indicate a plurality of workflows that can be initiated through the playbook. In various embodiments, only a subset of the workflows run when executing the playbook. Further, the subset of workflows that are run when executing the playbook can change between different playbook executions.

The input can define different types of triggers to form the plurality of distinct triggers. Specifically, the plurality of distinct triggers can comprise record-based triggers and scheduled query triggers for the playbook. In turn, any trigger in the combination of record-based triggers and scheduled query triggers can trigger execution of the playbook.

Further, the plurality of distinct triggers can each be defined relative to different trigger records associated with the playbook. A trigger record associated with a trigger can be the same record as a parent record for the playbook. Further, a trigger record associated with a trigger can be a different record from the parent record of the playbook. Defining triggers relative to a trigger record that is different from a parent record of the playbook is technically advantageous as information from not just the parent record, but also a trigger record that is different from the parent record, can be used in executing the playbook. In turn, playbooks can be designed with flexibility that leverages using input objects from records separate from the parent record for the playbook. More specifically, playbooks can be designed to meet specific needs by using input objects from specific records that are distinct from the parent record for the playbook.

At module 404, the distinct triggers are associated with the playbook. In associating the distinct triggers with the playbook, the playbook can be updated/maintained to associate the distinct triggers with the playbook. Specifically, the playbook can be configured to be launched if any of the distinct triggers are met.

In being defined relative to different trigger records, each of the plurality of distinct triggers can pass different information as execution input for the playbook. Specifically, each of the district triggers can pass different information from one of the different trigger records for which each of the distinct triggers is defined. Passing different information based on which trigger is activated is technically advantageous as it allows for configurability of the playbook at run time by varying inputs across different records. Specifically the input to the playbook can be decoupled from just the parent record, e.g. when the parent record also serves as the trigger record for one or more triggers for the playbook. More specifically, the playbook can be tied to different trigger records that correspond to the different triggers for the playbook to create input diversity for the playbook at run time. Increasing the input diversity for the playbook is technically advantageous as it allows for a single copy of the playbook to execute on input from different records without having to copy the playbook for each record. In turn, utilization of computational resources associated with copying the playbook is reduced.

At module 406, execution of the playbook is facilitated in response to satisfaction of a trigger of the plurality of distinct triggers. In facilitating execution of the playbook, steps of stages/workflows in the playbook can be presented to an operator implementing the playbook. Further in facilitating execution of the playbook, steps of stages/workflows in the playbook can be executed by or for an operator. In turn, the operator can execute the playbook in attempting to achieve the objective of the playbook.

In executing the playbook in response to satisfaction of a trigger from multiple triggers of the playbook, the playbook can be launched based on the trigger without replicating the playbook multiple times for each of the triggers. Specifically, only one copy of the playbook can be used in executing the playbook from each of the multiple triggers. Executing the playbook based on multiple triggers without replicating the playbook for each of the triggers is technically advantageous as computational resources associated with duplicating the playbook for each trigger can be reduced.

In various embodiments, the plurality of distinct triggers can correspond to different versions of the playbook. In turn, satisfaction of the various triggers can cause execution of the different versions of the playbook based on which trigger is met. For example, a first trigger can be associated with executing a playbook variant that is specific to a first region and a second trigger can be associated with executing a playbook variant that is specific to a second region. As follows, if the first trigger is met, then the first variant of the playbook for the first region can be launched, and if the second trigger is met, then the second variant of the playbook for the second region can be launched.

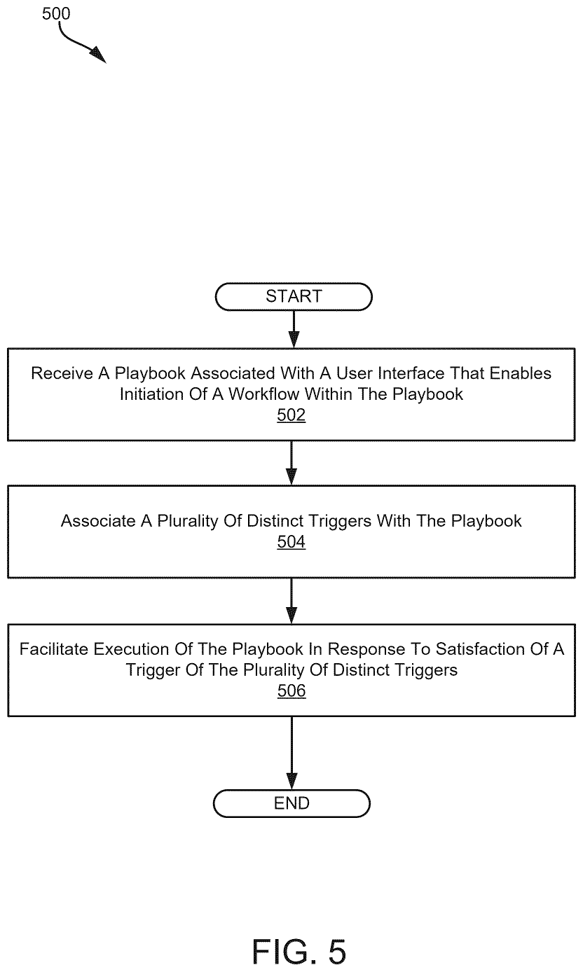

FIG. 5 illustrates a flowchart 500 of another example method of generating and implementing a playbook with multiple distinct triggers, according to some examples of the present disclosure. The method shown in FIG. 5 is provided by way of example, as there are a variety of ways to carry out the method. Additionally, while the example method is illustrated with a particular order of steps, those of ordinary skill in the art will appreciate that FIG. 5 and the modules shown therein can be executed in any order and can include fewer or more modules than illustrated. Each module shown in FIG. 5 represents one or more steps, processes, methods or routines in the method. The modules will be discussed with respect to the example architectures described herein.

At module 502, a playbook associated with a user interface that enables initiation of a workflow within the playbook is received. Specifically, the playbook can be received through the user interface from a user, e.g. the playbook creator. More specifically, the playbook can be generated based on a series of user inputs directed to the user interface. The user inputs can specify steps, workflows, actions, conditional actions, conditions for performing such actions to include, or otherwise initiate, in forming the playbook, instructions for forming the playbook, instructions for running the playbook, or a combination thereof. The playbook can indicate workflows that can be run in executing the playbook. The workflows of the playbook can comprise the workflow that is initiated through the user interface. A subset of the total workflows that form the playbook can be run in a single instance of executing the playbook.

At module 504, a plurality of distinct triggers is associated with the playbook. The distinct triggers can comprise different types of triggers. For example, the distinct triggers can comprise a first trigger of a first trigger type, e.g. a record-based trigger. Further in the example, the distinct triggers can comprise a second trigger of a second trigger type, e.g. a scheduled query trigger. The triggers can be defined based on received input. Specifically, the triggers can be defined based on input received through the user interface used in creating the playbook. Providing a user the ability to define distinct triggers for a playbook through a user interface is technically advantageous as a user can customize a workflow or versions of the workflow to fit the user's needs, e.g. enterprise needs. Further, the user can control what input is passed to the playbook by configuring the triggers records associated with the triggers through the user interface. The tailoring of the data input through the user interface provides further control to the user in managing the playbook to meet specific needs.

At module 506, execution of the playbook is facilitated in response to satisfaction of a trigger of the plurality of distinct triggers. Specifically, input that is generated based on the trigger can be passed to the playbook. As follows, the playbook can be executed based on the input and input from the parent record, e.g. if the parent record is different from a trigger record associated with the trigger.

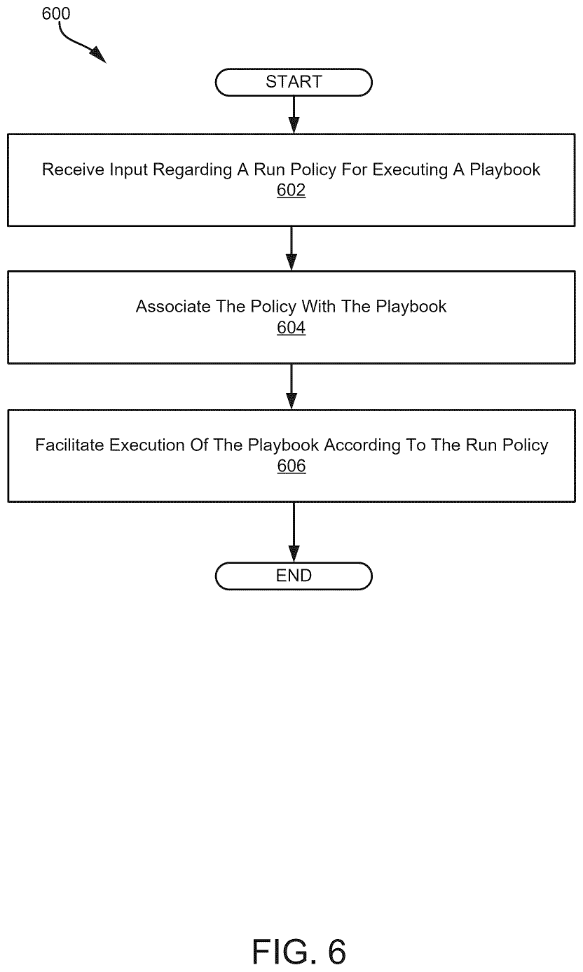

FIG. 6 illustrates a flowchart 600 of an example method of maintaining a run policy for a playbook and implementing the run policy in executing the playbook, according to some examples of the present disclosure. The method shown in FIG. 6 is provided by way of example, as there are a variety of ways to carry out the method. Additionally, while the example method is illustrated with a particular order of steps, those of ordinary skill in the art will appreciate that FIG. 6 and the modules shown therein can be executed in any order and can include fewer or more modules than illustrated. Each module shown in FIG. 6 represents one or more steps, processes, methods or routines in the method. The modules will be discussed with respect to the example architectures described herein.

At module 602, input regarding a run policy for executing the playbook is received. The input can be received along with input regarding triggers for the playbook. The run policy can specify rule for launching the playbook. More specifically, the run policy can specify rules for launching the playbook in response to satisfaction of one or more triggers for the playbook.

At module 604, the policy is associated with the playbook. The policy can be associated with the playbook in relation to one or more triggers associated with the playbook. For example, schedule query triggers can be defined in relation to a run policy including sorting criteria. For example, a playbook author could set up a daily scheduled query trigger that queries the contact table for the records that have not logged in for the past 30 days. To prevent excessive, e.g. and concurrent, playbook executions, the author can set a limit on the number of launched playbooks per day, e.g. ten. On the first day, each of the top ten matched contacts can trigger a playbook execution. However, if the run strategy is set to run once and no contacts have logged in on the first day, the same top ten matched contacts won't trigger any playbook on the second day. Accordingly, the sorting criteria can be modified to query the top ten matched contacts who are allowed to trigger playbook executions by the running strategy. As follows, another ten playbook instances can be run in association with the next top ten matched contacts.

At module 606, execution of the playbook is facilitated according to the run policy. Specifically, regardless of whether a trigger is met, the playbook is launched according to the run policy. Launching the playbook according to the run policy irrespective of trigger satisfaction is technically advantageous as it can prevent excessive executions of the playbook. For example, the run policy can specify not running another instance of the playbook concurrently with another playbook execution. In turn, controlling excessive execution of the playbook through the run policy can save computational resources that would otherwise be expended in executing the playbook.

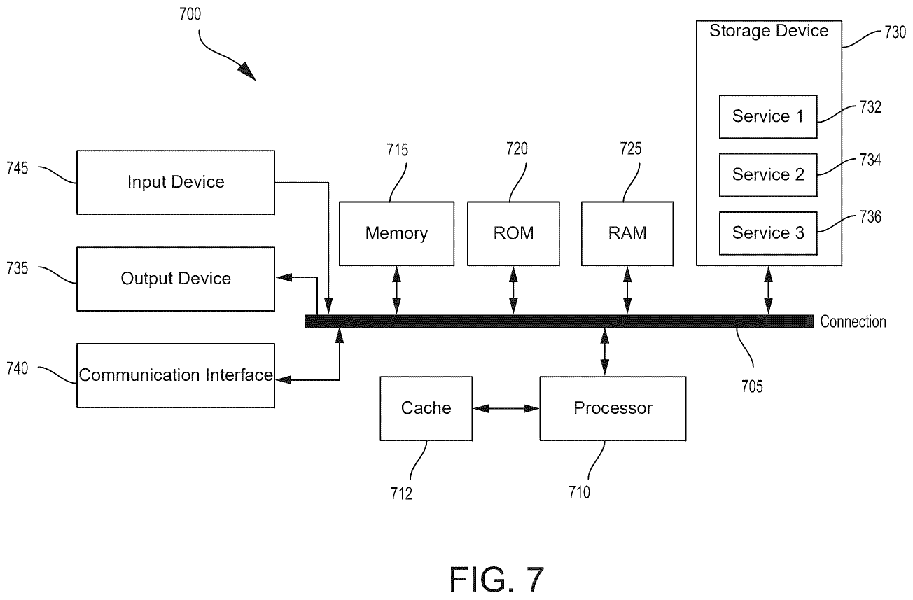

FIG. 7 illustrates an example processor-based system with which some embodiments of the subject technology can be implemented. For example, processor-based system 700 can be any computing device making up, or any component thereof in which the components of the system are in communication with each other using connection 705. Connection 705 can be a physical connection via a bus, or a direct connection into processor 710, such as in a chipset architecture. Connection 705 can also be a virtual connection, networked connection, or logical connection.

In some embodiments, computing system 700 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example system 700 includes at least one processing unit (Central Processing Unit (CPU) or processor) 710 and connection 705 that couples various system components including system memory 715, such as Read-Only Memory (ROM) 720 and Random-Access Memory (RAM) 725 to processor 710. Computing system 700 can include a cache of high-speed memory 712 connected directly with, in close proximity to, or integrated as part of processor 710.

Processor 710 can include any general-purpose processor and a hardware service or software service, such as services 732, 734, and 736 stored in storage device 730, configured to control processor 710 as well as a special-purpose processor where software instructions are incorporated into the actual processor design. Processor 710 may essentially be a completely self-contained computing system, containing multiple cores or processors, a bus, memory controller, cache, etc. A multi-core processor may be symmetric or asymmetric.

To enable user interaction, computing system 700 includes an input device 745, which can represent any number of input mechanisms, such as a microphone for speech, a touch-sensitive screen for gesture or graphical input, keyboard, mouse, motion input, speech, etc. Computing system 700 can also include output device 735, which can be one or more of a number of output mechanisms known to those of skill in the art. In some instances, multimodal systems can enable a user to provide multiple types of input/output to communicate with computing system 700. Computing system 700 can include communications interface 740, which can generally govern and manage the user input and system output. The communication interface may perform or facilitate receipt and/or transmission wired or wireless communications via wired and/or wireless transceivers, including those making use of an audio jack/plug, a microphone jack/plug, a Universal Serial Bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a Radio-Frequency Identification (RFID) wireless signal transfer, Near-Field Communications (NFC) wireless signal transfer, Dedicated Short Range Communication (DSRC) wireless signal transfer, 802.11 Wi-Fi® wireless signal transfer, Wireless Local Area Network (WLAN) signal transfer, Visible Light Communication (VLC) signal transfer, Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer signal transfer, ultraviolet light signal transfer, wireless signal transfer along the electromagnetic spectrum, or some combination thereof.

Communication interface 740 may also include one or more Global Navigation Satellite System (GNSS) receivers or transceivers that are used to determine a location of the computing system 700 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 730 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a Compact Disc (CD) Read Only Memory (CD-ROM) optical disc, a rewritable CD optical disc, a Digital Video Disk (DVD) optical disc, a Blu-ray Disc (BD) optical disc, a holographic optical disk, another optical medium, a Secure Digital (SD) card, a micro SD (microSD) card, a Memory Stick® card, a smartcard chip, a EMV chip, a Subscriber Identity Module (SIM) card, a mini/micro/nano/pico SIM card, another Integrated Circuit (IC) chip/card, Random-Access Memory (RAM), Atatic RAM (SRAM), Dynamic RAM (DRAM), Read-Only Memory (ROM), Programmable ROM (PROM), Erasable PROM (EPROM), Electrically Erasable PROM (EEPROM), flash EPROM (FLASHEPROM), cache memory (L1/L2/L3/L4/L5/L #), Resistive RAM (RRAM/ReRAM), Phase Change Memory (PCM), Spin Transfer Torque RAM (STT-RAM), another memory chip or cartridge, and/or a combination thereof.

Storage device 730 can include software services, servers, services, etc., that when the code that defines such software is executed by the processor 710, it causes the system 700 to perform a function. In some embodiments, a hardware service that performs a particular function can include the software component stored in a computer-readable medium in connection with the necessary hardware components, such as processor 710, connection 705, output device 735, etc., to carry out the function.

Embodiments within the scope of the present disclosure may also include tangible and/or non-transitory computer-readable storage media or devices for carrying or having computer-executable instructions or data structures stored thereon. Such tangible computer-readable storage devices can be any available device that can be accessed by a general purpose or special purpose computer, including the functional design of any special purpose processor as described above. By way of example, and not limitation, such tangible computer-readable devices can include RAM, ROM, EEPROM, CD-ROM or other optical disk storage, magnetic disk storage or other magnetic storage devices, or any other device which can be used to carry or store desired program code in the form of computer-executable instructions, data structures, or processor chip design. When information or instructions are provided via a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable storage devices.

Computer-executable instructions include, for example, instructions and data which cause a general-purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform tasks or implement abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Other embodiments of the disclosure may be practiced in network computing environments with many types of computer system configurations, including personal computers, hand-held devices, multi-processor systems, microprocessor-based or programmable consumer electronics, network Personal Computers (PCs), minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

### SELECTED EXAMPLES

Illustrative examples of the disclosure include:

Embodiment 1. A computer-implemented method comprising: receiving input regarding a plurality of distinct triggers for a playbook, wherein the playbook indicates a plurality of workflows; associating the plurality of distinct triggers with the playbook; and facilitating execution of the playbook in response to satisfaction of a trigger of the plurality of distinct triggers.

Embodiment 2. The computer-implemented method of Embodiment 1, wherein the playbook is associated with a user interface that enables generation of a particular workflow of the plurality of workflows.

Embodiment 3. The computer-implemented method of either Embodiment 1 or 2, wherein the playbook comprises a plurality of conditional actions and conditions forming the plurality of workflows in a hierarchy and a traversal path of a subset of the workflows in the hierarchy is dependent on meeting one or more of the conditions.

Embodiment 4. The computer-implemented method of Embodiment 3, wherein the traversal path excludes a workflow of the plurality of workflows so that the workflow is excluded from a playbook execution.

Embodiment 5. The computer-implemented method of any of Embodiments 1 through 4, wherein a trigger of the distinct triggers is defined by one or more conditions specified by the input.

Embodiment 6. The computer-implemented method of Embodiment 5, wherein the one or more conditions are defined relative to a trigger record associated with the playbook.

Embodiment 7. The computer-implemented method of Embodiment 6, wherein the input specifies a relationship between the trigger record and a parent record, the method further comprising connecting the trigger record and the parent record based on the input to facilitate identification of the parent record based on the trigger record.

Embodiment 8. The computer-implemented method of any of Embodiments 1 through 7, wherein the plurality of distinct triggers are each defined relative to different trigger records associated with the playbook.

Embodiment 9. The computer-implemented method of any of Embodiments 1 through 8, wherein each of the plurality of distinct triggers passes different information as execution input for the playbook.

Embodiment 10. The computer-implemented method of any of Embodiments 1 through 9, wherein the plurality of distinct triggers comprise a scheduled query trigger defined by a temporal value for determining if a condition is met.

Embodiment 11. The computer-implemented method of Embodiment 10, further comprising querying a parent record of the playbook according to the temporal value; and running the playbook based on satisfaction of the condition in the parent record.

Embodiment 12. The computer-implemented method of any of Embodiments 1 through 11, wherein the plurality of distinct triggers correspond to different versions of the playbook and cause execution of the different versions of the playbook based on which trigger is met.

Embodiment 13. The computer-implemented method of any of Embodiments 1 through 12, wherein the input indicates a run strategy for the playbook, the method further comprising: defining the run strategy relative to a parent record associated with the playbook; and facilitating execution of the playbook according to the run strategy.

Embodiment 14. The computer-implemented method of Embodiment 13, wherein the run strategy specifies the parent record is associated with a single playbook execution, the parent record is associated with multiple executions of the playbook, a playbook execution can be launched based on whether the playbook is currently running for the parent record, the playbook execution can be launched based on previous executions of the playbook for the parent record relative to a temporal value, or a combination thereof.

Embodiment 15. A computer-implemented method comprising: receiving a playbook that indicates a plurality of workflows; associating a plurality of distinct triggers with the playbook; and while the plurality of distinct triggers is associated with the playbook, facilitating execution of the playbook in response to satisfaction of a trigger of the plurality of distinct triggers.

Embodiment 16. The computer-implemented method of Embodiment 15, wherein the playbook is associated with a user interface that enables initiation of a particular workflow of the plurality of workflows.

Embodiment 17. The computer-implemented method of Embodiment 16, wherein initiation of the particular workflow is based on a series of user inputs directed to the user interface.

Embodiment 18. The computer-implemented method of any of Embodiments 15 through 17, wherein the plurality of distinct triggers includes a first trigger of a first trigger type and a second trigger of a second trigger type different from the first trigger type.

Embodiment 19. The computer-implemented method of Embodiment 18, wherein the first trigger type is a record-based trigger, and wherein the second trigger type is a scheduled query trigger.

Embodiment 20. The computer-implemented method of any of Embodiments 15 through 19, wherein the playbook comprises a plurality of conditional actions and conditions forming a plurality of workflows in a hierarchy and a traversal path of a subset of the workflows in the hierarchy is dependent on meeting one or more of the conditions.

Embodiment 21. The computer-implemented method of any of Embodiments 15 through 20, wherein the plurality of workflows includes a first workflow and a second workflow that are together executable to satisfy an objective of the playbook.

Embodiment 22. The computer-implemented method of Embodiment 21, further comprising satisfying the objective by executing the second workflow after completing execution of the first workflow.

Embodiment 23. A system comprising: one or more processors; and at least one computer-readable storage medium having stored therein instructions which, when executed by the one or more processors, cause the one or more processors to: receive input regarding a plurality of distinct triggers for a playbook, wherein the playbook indicates a plurality of workflows; set the plurality of distinct triggers for the playbook; and facilitate execution of the playbook in response to satisfaction of a trigger of the plurality of distinct triggers.

Embodiment 24. A system comprising means for performing a method according to any of Embodiments 1 through 14.

Embodiment 25. A system comprising means for performing a method according to any of Embodiments 15 through 22.

The various embodiments described above are provided by way of illustration only and should not be construed to limit the scope of the disclosure. For example, the principles herein apply equally to optimization as well as general improvements. Various modifications and changes may be made to the principles described herein without following the example embodiments and applications illustrated and described herein, and without departing from the spirit and scope of the disclosure.

Claim language or other language in the disclosure reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

What is claimed is:

1. A computer-implemented method comprising:
receiving input regarding a plurality of distinct triggers for a playbook, wherein the playbook indicates a plurality of workflows;
associating the plurality of distinct triggers with the playbook; and
facilitating execution of the playbook in response to satisfaction of a trigger of the plurality of distinct triggers.

2. The computer-implemented method of claim 1, wherein the playbook is associated with a user interface that enables generation of a particular workflow of the plurality of workflows.

3. The computer-implemented method of claim 1, wherein the playbook comprises a plurality of conditional actions and conditions forming the plurality of workflows in a hierarchy and a traversal path of a subset of the workflows in the hierarchy is dependent on meeting one or more of the conditions.

4. The computer-implemented method of claim 3, wherein the traversal path excludes a workflow of the plurality of workflows so that the workflow is excluded from a playbook execution.

5. The computer-implemented method of claim 1, wherein a trigger of the distinct triggers is defined by one or more conditions specified by the input.

6. The computer-implemented method of claim 5, wherein the one or more conditions are defined relative to a trigger record associated with the playbook.

7. The computer-implemented method of claim 6, wherein the input specifies a relationship between the trigger record and a parent record, the method further comprising connecting the trigger record and the parent record based on the input to facilitate identification of the parent record based on the trigger record.

8. The computer-implemented method of claim 1, wherein the plurality of distinct triggers are each defined relative to different trigger records associated with the playbook.

9. The computer-implemented method of claim 1, wherein each of the plurality of distinct triggers passes different information as execution input for the playbook.

10. The computer-implemented method of claim 1, wherein the plurality of distinct triggers comprise a scheduled query trigger defined by a temporal value for determining if a condition is met.

11. The computer-implemented method of claim 10, further comprising:
querying a parent record of the playbook according to the temporal value; and
running the playbook based on satisfaction of the condition in the parent record.

12. The computer-implemented method of claim 1, wherein the plurality of distinct triggers correspond to different versions of the playbook and cause execution of the different versions of the playbook based on which trigger is met.

13. The computer-implemented method of claim 1, wherein the input indicates a run strategy for the playbook, the method further comprising:
defining the run strategy relative to a parent record associated with the playbook; and
facilitating execution of the playbook according to the run strategy.

14. The computer-implemented method of claim 13, wherein the run strategy specifies the parent record is associated with a single playbook execution, the parent record is associated with multiple executions of the playbook, a playbook execution can be launched based on whether the playbook is currently running for the parent record, the playbook execution can be launched based on previous executions of the playbook for the parent record relative to a temporal value, or a combination thereof.

15. A computer-implemented method comprising:
receiving a playbook that indicates a plurality of workflows;
associating a plurality of distinct triggers with the playbook; and
while the plurality of distinct triggers is associated with the playbook, facilitating execution of the playbook in response to satisfaction of a trigger of the plurality of distinct triggers.

16. The computer-implemented method of claim 15, wherein the playbook is associated with a user interface that enables initiation of a particular workflow of the plurality of workflows.

17. The computer-implemented method of claim 16, wherein initiation of the particular workflow is based on a series of user inputs directed to the user interface.

18. The computer-implemented method of claim 15, wherein the plurality of distinct triggers includes a first trigger of a first trigger type and a second trigger of a second trigger type different from the first trigger type.

19. The computer-implemented method of claim 18, wherein the first trigger type is a record-based trigger, and wherein the second trigger type is a scheduled query trigger.

20. The computer-implemented method of claim 15, wherein the playbook comprises a plurality of conditional actions and conditions forming a plurality of workflows in a hierarchy and a traversal path of a subset of the workflows in the hierarchy is dependent on meeting one or more of the conditions.

21. The computer-implemented method of claim 15, wherein the plurality of workflows includes a first workflow and a second workflow that are together executable to satisfy an objective of the playbook.

22. The computer-implemented method of claim 21, further comprising satisfying the objective by executing the second workflow after completing execution of the first workflow.

23. A system comprising:
one or more processors; and
at least one computer-readable storage medium having stored therein instructions which, when executed by the one or more processors, cause the one or more processors to:
receive input regarding a plurality of distinct triggers for a playbook, wherein the playbook indicates a plurality of workflows;
set the plurality of distinct triggers for the playbook; and
facilitate execution of the playbook in response to satisfaction of a trigger of the plurality of distinct triggers.
